(19) United States
(12) Patent Application Publication
(10) Pub. No.: US 2014/0355800 A1
(43) Pub. Date: Dec. 4, 2014

(54) HEARING-AID APPARATUS AND METHOD USING ULTRASONIC WAVES

(71) Applicant: Electronics and Telecommunications Research Institute, Daejeon (KR)

(72) Inventors: Tae Wook KANG, Daejeon (KR); Jung Hwan HWANG, Daejeon (KR); Sung Eun KIM, Daejeon (KR); Sung Weon KANG, Daejeon (KR); Chang Hee HYOUNG, Daejeon (KR); Kyung Hwan PARK, Daejeon (KR); Sung Won SOHN, Daejeon (KR)

(73) Assignee: Electronics and Telecommunications Research Institute, Daejeon (KR)

(21) Appl. No.: 14/287,796

(22) Filed: May 27, 2014

(30) Foreign Application Priority Data
May 30, 2013 (KR) 10-2013-0062017

(51) Int. Cl. H04R 25/00

(52) U.S. Cl. CPC H04R 25/554; H04R 2460/00
USPC 381/315

(57) ABSTRACT

A hearing-aid apparatus using ultrasonic waves is inserted and mounted within an external auditory meatus of an ear, generates an ultrasonic wave band signal by single side band amplitude modulation of a sound signal that is received through a microphone, and outputs the ultrasonic wave band signal and a carrier signal that is used for single side band amplitude modulation as an ultrasonic wave signal to a transfer medium in a predetermined beam direction. Therefore, the ultrasonic wave signal forms a focal area in a damaged hearing organ area, the ultrasonic wave band signal is restored to a sound signal by nonlinear characteristics of a transfer medium in the focal area, and the damaged hearing organ detects the sound signal.

### CROSS-REFERENCE TO RELATED APPLICATION

This application claims priority to and the benefit of Korean Patent Application No. 1 0-201 3-006201 7 filed in the Korean Intellectual Property Office on May 30, 2013, the entire contents of which are incorporated herein by reference.

### BACKGROUND OF THE INVENTION

(a) Field of the Invention

The present invention relates to a hearing-aid apparatus and method using ultrasonic waves.

(b) Description of the Related Art

An existing hearing-aid apparatus enables a damaged hearing organ to recognize a sound band signal by amplifying the sound band signal that is received through a microphone and transferring the amplified sound band signal through a speaker.

However, when amplifying the signal, the existing hearing-aid apparatus has a problem that power consumption is high and a signal cannot be selectively applied to a specific damaged area.

### SUMMARY OF THE INVENTION

The present invention has been made in an effort to provide a hearing-aid method and apparatus using ultrasonic waves having advantages of being capable of reducing power consumption and applying a signal to a damaged hearing organ.

An exemplary embodiment of the present invention provides a hearing-aid apparatus using ultrasonic waves. The hearing-aid apparatus includes: a microphone that receives a sound signal; a signal processor that generates an ultrasonic wave band signal by single side band amplitude modulation of the sound signal; and an ultrasonic wave element array that includes a plurality of ultrasonic wave elements and that outputs an ultrasonic wave band signal and a carrier signal that is used for single side band amplitude modulation as an ultrasonic wave signal in a predetermined beam direction to a transfer medium, wherein the hearing-aid apparatus is inserted and mounted within an external auditory meatus of an ear.

The transfer medium may include air.

The transfer medium may include skin and a cartilage of the external auditory meatus.

The signal processor may include a controller that controls the beam direction of the ultrasonic wave element array in order for the ultrasonic wave signal to form a focal area in a damaged hearing organ area.

The signal processor may control at least one of a phase and an amplitude of an ultrasonic wave band signal that is input to the plurality of ultrasonic wave elements in order for the ultrasonic wave signal to form a focal area in a damaged hearing organ area.

The signal processor may include a distortion compensator that performs pre-processing of the ultrasonic wave band signal for compensating signal distortion occurring when the ultrasonic wave signal is demodulated to the sound signal by nonlinearity of the transfer medium.

The ultrasonic wave element array may be formed with an element having the same impedance as that of the transfer medium.

Another embodiment of the present invention provides a hearing-aid method of a hearing-aid apparatus using ultrasonic waves. The hearing-aid method includes: receiving a sound signal; modulating the sound signal to an ultrasonic wave band signal; outputting the ultrasonic wave band signal and a carrier signal that is used for the modulation as an ultrasonic wave signal to a transfer medium in a predetermined beam direction; forming a focal area of the ultrasonic wave signal in a damaged hearing organ area; and restoring the ultrasonic wave band signal to a sound signal by nonlinear characteristics of the transfer medium in the focal area.

The transfer medium may include air.

The transfer medium may include skin and a cartilage of the external auditory meatus.

The modulating of the sound signal may include modulating the sound signal by single side band amplitude modulation.

The outputting of the ultrasonic wave band signal may include enabling the ultrasonic wave band signal and the carrier signal that is used for the modulation to pass through the ultrasonic wave element array, and the forming of a focal area may include controlling a beam direction of the ultrasonic wave element array so as to form the focal area in the damaged hearing organ area.

The controlling of a beam direction may include controlling at least one of a phase and an amplitude of an ultrasonic wave band signal that is input to each ultrasonic wave element that forms the ultrasonic wave element array.

### BRIEF DESCRIPTION OF THE DRAWINGS

FIG. 1 is a block diagram illustrating a hearing-aid apparatus using ultrasonic waves according to an exemplary embodiment of the present invention.

FIG. 2 is a flowchart illustrating a hearing-aid method using ultrasonic waves according to an exemplary embodiment of the present invention.

FIG. 3 is a block diagram illustrating a signal processor of FIG. 1.

FIGS. 4 and 5 are diagrams illustrating an example of an ultrasonic wave element array of a hearing-aid apparatus using ultrasonic waves according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the specification and claims, unless explicitly described to the contrary, the word “comprise” and variations such as “comprises” or “comprising” will be understood to imply the inclusion of stated elements but not the exclusion of any other elements.

Hereinafter, a hearing-aid method and apparatus using ultrasonic waves according to an exemplary embodiment of the present invention will be described in detail with reference to the drawings.

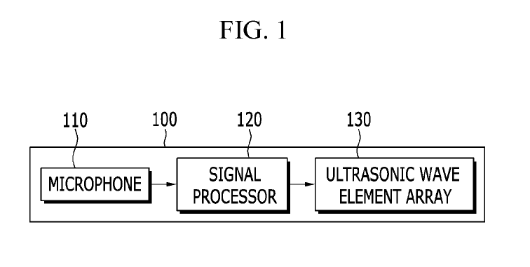

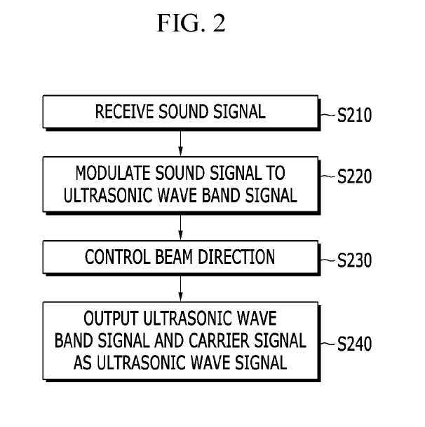

FIG. 1 is a block diagram illustrating a hearing-aid apparatus using ultrasonic waves according to an exemplary embodiment of the present invention, and FIG. 2 is a flowchart illustrating a hearing-aid method using ultrasonic waves according to an exemplary embodiment of the present invention.

Referring to FIG. 1, a hearing-aid apparatus 100 includes a microphone 110, a signal processor 120, and an ultrasonic wave element array 130. Such a hearing-aid apparatus 100 is inserted and mounted in an external auditory meatus of an ear, which is a hearing organ.

Referring to FIG. 2, the microphone 110 receives a sound signal from the outside (S210) and outputs the sound signal to the signal processor 120.

The signal processor 120 modulates the sound signal that is output from the microphone 110 to an ultrasonic wave band signal through single side band (SSB) amplitude modulation (AM) (S220), and outputs the modulated ultrasonic wave band signal to the ultrasonic wave element array 130. SSB AM modulates a sound signal of which the amplitude is modulated to a carrier, and uses one of two upper and lower side bands using a carrier frequency as a symmetry axis as an ultrasonic wave band signal. The signal processor 120 may amplify an ultrasonic wave band signal as needed.

The ultrasonic wave element array 130 includes a plurality of ultrasonic wave elements, and the plurality of ultrasonic wave elements are arranged in an array in which beam forming that can transfer a signal in a desired beam direction is possible. The ultrasonic wave element array 130 outputs an ultrasonic wave band signal and a carrier signal that is used for SSB modulation in a predetermined direction as an ultrasonic wave signal (S240). The ultrasonic wave element array 130 may be formed as a linear array or a plane array. The linear array indicates a structure in which the center of an ultrasonic wave element is located along a straight line. The plane array indicates a structure in which the center of an ultrasonic wave element is located at a plane. The plane array may include a circular array and a rectangular array having the center of an ultrasonic wave element within a circular area and a rectangular area, respectively. A beam direction of beam forming and the number of ultrasonic wave elements that are used for beam forming may be defined by directionality of the ultrasonic wave element that is attached to or inserted in a human body, or may be changed by a user's input value.

An ultrasonic wave signal that is output from the ultrasonic wave element array 130 is applied to a damaged hearing organ, and the ultrasonic wave signal forms a focal area in the damaged hearing organ area. In the focal area, by nonlinear characteristics of a transfer medium of the ultrasonic wave signal, the ultrasonic wave band signal is restored to a sound signal of an audible band and thus the hearing organ detects the sound signal. In this case, a transfer medium may be air, or may be skin or a cartilage of the external auditory meatus.

The signal processor 120 may control a beam direction of the ultrasonic wave element array 130 to form a focal area in a damaged hearing organ area (S230). The signal processor 120 may control a beam direction of the ultrasonic wave element array 130 by controlling a phase and an amplitude of an ultrasonic wave band signal that is input to each ultrasonic wave element.

In this way, by controlling a beam direction of the ultrasonic wave element array 130, the ultrasonic wave element array 130 may selectively and intensively transfer a sound signal only to a specific area. This is, because a sound signal may be transferred only to the damaged organ, unnecessary stimulation of a non-damaged organ can be minimized. Further, because a widely transmitted ultrasonic wave band signal can be intensively transmitted, by minimizing a magnitude of an ultrasonic wave band signal, power consumption necessary for amplification can be minimized.

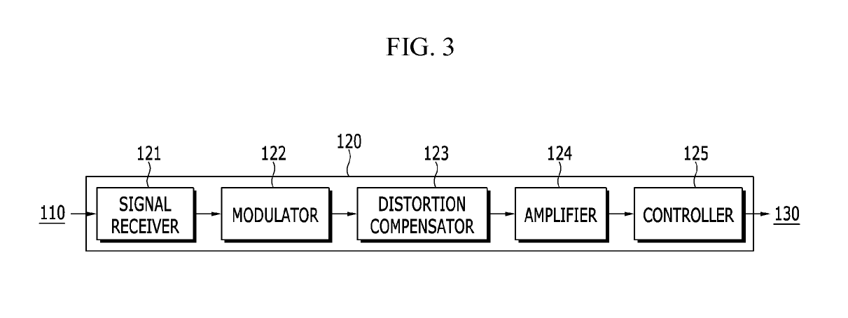

FIG. 3 is a block diagram illustrating a signal processor of FIG. 1.

Referring to FIG. 3, the signal processor 120 includes a signal receiver 121, a modulator 122, a distortion compensator 123, an amplifier 124, and a controller 125.

The signal receiver 121 receives a sound signal from the microphone 110 and performs pre-processing of the sound signal. The pre-processing includes filtering for removing noise from a sound signal, and may include a band limitation function of limiting a band of a sound signal. When the modulator 122 performs digital modulation, the pre-processing may further include an ADC function of converting a sound signal from an analog signal to a digital signal. Further, when the modulator 122 performs analog modulation, the pre-processing may further include a signal magnitude limitation function of limiting a magnitude of a sound signal to a magnitude appropriate for analog modulation.

The modulator 122 generates an ultrasonic wave band signal by SSB AM of the pre-processed sound signal. When the modulator 122 performs analog modulation, the modulator 122 may include an analog mixer and a filter, and may perform digital modulation through digital signal processing (DSP). When the modulator 122 performs analog modulation, the modulator 122 may modulate a sound signal with a double side band modulation method and generate a single side band signal to use as an ultrasonic wave band signal through a filter. When the modulator 122 performs digital modulation, the modulator 122 may perform SSB AM by applying Weaver modulation.

In order to minimize distortion of an ultrasonic wave band signal, the distortion compensator 123 pre-processes the ultrasonic wave band signal. Specifically, the distortion compensator 123 performs pre-processing of the ultrasonic wave band signal for compensating signal distortion generating when the ultrasonic wave band signal is demodulated to a sound signal or signal distortion generating by characteristics of a transfer medium.

For example, a sound signal p(t) of an audible band that is demodulated in a nonlinear medium is proportional to second differentiation of a square of an envelope signal E(t) corresponding to an envelope of a signal in which amplitude is modulated by time as in Equation 1.

$$p ( t ) ∝ \frac{{d}^{2} \{ {E ( t )}^{2} \}}{d {t}^{2}} \qquad ( Equation 1 )$$

In order to compensate this, the distortion compensator 123 performs pre-processing of the ultrasonic wave band signal that is transferred using ultrasonic waves so as to obtain an effect of Equation 2.

(Equation 2)

E^{f}(t)=[1+∫∫g(t)dt²]^{1/2}

In Equation 2, g(t) represents a sound signal that is used for modulation.

Because an influence by second differentiation is represented with frequency response characteristics having a slope of 12 dB/octave, the distortion compensator 123 enables integral calculus of g(t) of Equation 2 to pass though an equalizer of 12 dB/octave and compensates distortion of a sound signal through a square root operation.

The amplifier 124 amplifies the ultrasonic wave band signal of which signal distortion is compensated. In this case, because the ultrasonic wave band signal can be selectively applied to a specific area through beam direction control of the ultrasonic wave element array 130, an amplification gain of the amplifier 124 may not be greatly increased. Further, when the ultrasonic wave band signal of which the signal distortion is compensated has sufficient power to drive the ultrasonic wave element array 130, the ultrasonic wave band signal of which the signal distortion is compensated may be immediately transferred to the controller 125.

The controller 125 outputs the ultrasonic wave band signal to the ultrasonic wave element array 130. Further, the controller 125 controls a beam direction of the ultrasonic wave element array 130. The controller 125 controls the phase and amplitude of the ultrasonic wave band signal that is input to each ultrasonic wave element so that the ultrasonic wave signal that is output from the ultrasonic wave element array 130 may be input in an oblique direction instead of perpendicular to a human body.

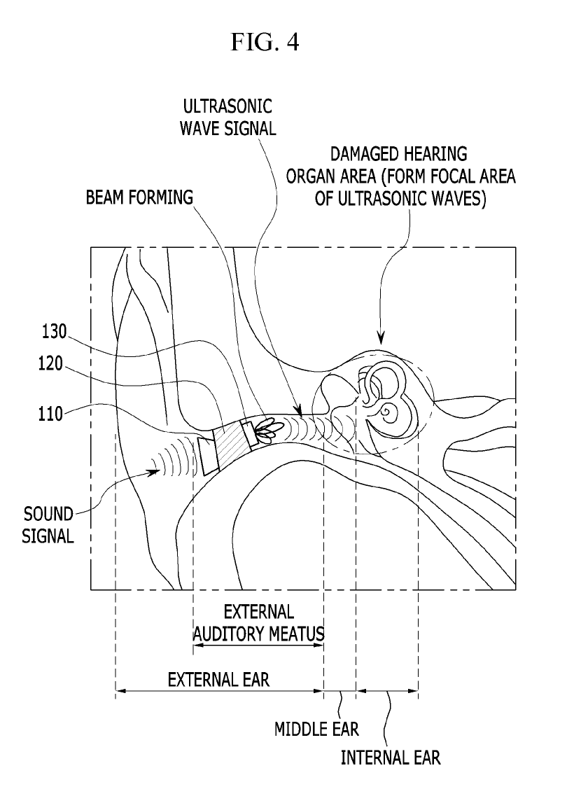

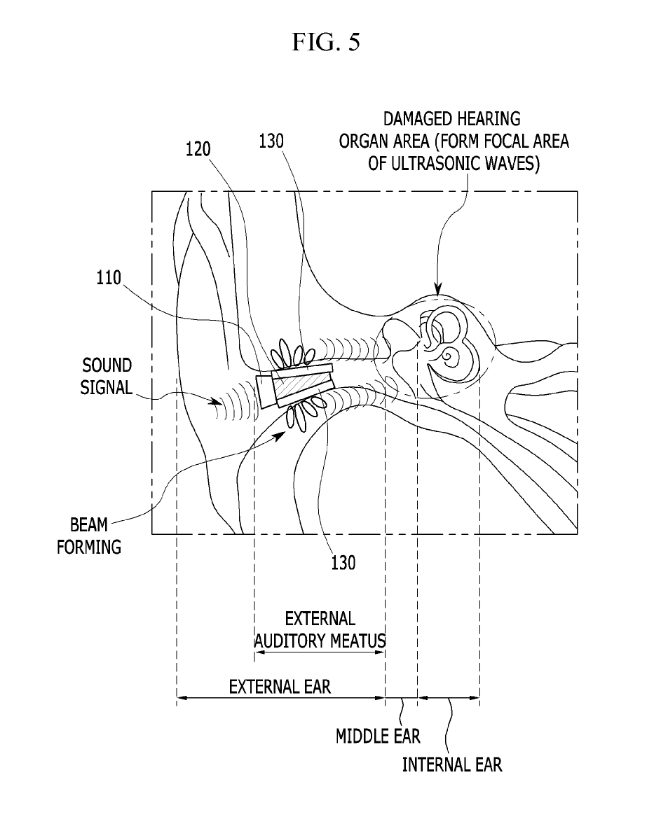

FIGS. 4 and 5 are diagrams illustrating an example of an ultrasonic wave element array of a hearing-aid apparatus using ultrasonic waves according to an exemplary embodiment of the present invention.

Referring to FIG. 4, the hearing-aid apparatus 100 using ultrasonic waves uses air within an external auditory meatus as a medium that transfers the ultrasonic wave signal of the ultrasonic wave element array 130. That is, in order to transfer the ultrasonic wave signal of the ultrasonic wave element array 130 through air within an external auditory meatus, an output of the ultrasonic wave element array 130 is positioned toward the middle ear.

Further, in order to minimize reflection of the ultrasonic wave signal element, the ultrasonic wave element array 130 may be formed with an element having the same impedance as that of air.

The ultrasonic wave element array 130 transfers the ultrasonic wave signal to the air in a predetermined direction. The ultrasonic wave signal is applied to a damaged hearing organ among organs including an external ear, a middle ear, and an internal ear through directivity of the ultrasonic wave signal, and thus a focal area of ultrasonic waves is formed in the damaged hearing organ area, and in the focal area, an ultrasonic wave band signal that is modulated by a nonlinear property of air is restored to a sound signal.

Therefore, the hearing organ detects a sound signal.

Referring to FIG. 5, the hearing-aid apparatus 100 using ultrasonic waves uses a human body such as skin or a cartilage of the external auditory meatus that transfers the ultrasonic wave signal of the ultrasonic wave element array 130. That is, in order to transfer the ultrasonic wave signal of the ultrasonic wave element array 130 through the skin or cartilage of the external auditory meatus, the output of the ultrasonic wave element array 130 may be positioned toward the skin surface of the external auditory meatus, and in this case, at least one ultrasonic wave element array 130 may be used.

Further, in order to minimize reflection of the ultrasonic wave signal at a human body contact surface, the ultrasonic wave element array 130 may be formed with an element having the same impedance as that of a human body.

An ultrasonic wave signal that is transmitted with directionality to the human body forms a focal area with directivity at an appropriate position of a damaged hearing organ area, and in the focal area, the ultrasonic wave signal is restored to a sound signal by nonlinear characteristics of the human body, such that the hearing organ detects the restored sound signal.

In this way, when human body is used as the medium that transfers the ultrasonic wave signal, the sound signal can be transferred through skin or cartilage even to a specific hearing organ of the middle ear or the internal ear to which a signal that is transmitted through the air cannot be transferred.

According to an exemplary embodiment of the present invention, because a radiation direction of a signal can be selected through directivity of ultrasonic waves and beam forming of an ultrasonic wave element array, a signal can be intensively and directly applied to a specific damaged area of a hearing organ including an external ear, a middle ear, and an internal ear, and thus a signal can be effectively transferred even through a lower output signal.

Further, when an ultrasonic wave signal is transmitted to a human body, sound can be transferred through skin or a bone to a specific organ of a middle ear or an internal ear in which a signal that is transmitted to the air cannot be transferred.

Further, because the signal can be intensively applied to a specific portion, it is unnecessary to increase an amplification rate of an external signal, and thus power for amplifying a signal can be reduced.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A hearing-aid apparatus using ultrasonic waves, comprising:
a microphone that receives a sound signal;
a signal processor that generates an ultrasonic wave band signal by single side band amplitude modulation of the sound signal; and
an ultrasonic wave element array comprising a plurality of ultrasonic wave elements and that outputs an ultrasonic wave band signal and a carrier signal that is used for single side band amplitude modulation as an ultrasonic wave signal in a predetermined beam direction to a transfer medium,
wherein the hearing-aid apparatus is inserted and mounted within an external auditory meatus of an ear.

2. The hearing-aid apparatus of claim 1, wherein the transfer medium comprises air.

3. The hearing-aid apparatus of claim 1, wherein the transfer medium comprises skin and a cartilage of the external auditory meatus.

4. The hearing-aid apparatus of claim 1, wherein the signal processor comprises a controller that controls the beam direction of the ultrasonic wave element array in order for the ultrasonic wave signal to form a focal area in a damaged hearing organ area.

5. The hearing-aid apparatus of claim 1, wherein the signal processor controls at least one of a phase and an amplitude of an ultrasonic wave band signal that is input to the plurality of ultrasonic wave elements in order for the ultrasonic wave signal to form a focal area in a damaged hearing organ area.

6. The hearing-aid apparatus of claim 1, wherein the signal processor comprises a distortion compensator that performs pre-processing of the ultrasonic wave band signal for compensating signal distortion occurring when the ultrasonic wave signal is demodulated to the sound signal by nonlinearity of the transfer medium.

7. The hearing-aid apparatus of claim 1, wherein the ultrasonic wave element array is formed with an element having the same impedance as that of the transfer medium.

8. A hearing-aid method of a hearing-aid apparatus using ultrasonic waves, the hearing-aid method comprising:
receiving a sound signal;
modulating the sound signal to an ultrasonic wave band signal;
outputting the ultrasonic wave band signal and a carrier signal that is used for the modulation as an ultrasonic wave signal to a transfer medium in a predetermined beam direction;
forming a focal area of the ultrasonic wave signal in a damaged hearing organ area; and
restoring the ultrasonic wave band signal to a sound signal by nonlinear characteristics of the transfer medium in the focal area.

9. The hearing-aid method of claim 8, wherein the transfer medium comprises air.

10. The hearing-aid method of claim 8, wherein the transfer medium comprises skin and a cartilage of the external auditory meatus.

11. The hearing-aid method of claim 8, wherein the modulating of the sound signal comprises modulating the sound signal by single side band amplitude modulation.

12. The hearing-aid method of claim 8, wherein the outputting of the ultrasonic wave band signal comprises enabling the ultrasonic wave band signal and the carrier signal that is used for the modulation to pass through the ultrasonic wave element array, and
the forming of a focal area comprises controlling a beam direction of the ultrasonic wave element array so as to form the focal area in the damaged hearing organ area.

13. The hearing-aid method of claim 12, wherein the controlling of a beam direction comprises controlling at least one of a phase and an amplitude of an ultrasonic wave band signal that is input to each ultrasonic wave element that forms the ultrasonic wave element array.

14. The hearing-aid method of claim 8, further comprising performing pre-processing of the ultrasonic wave band signal for compensating distortion of the restored sound signal.

15. The hearing-aid method of claim 8, wherein the hearing-aid apparatus is inserted and mounted within an external auditory meatus of an ear.
